(19) United States
(12) Patent Application Publication
(10) Pub. No.: US 2025/0002086 A1
(43) Pub. Date: Jan. 2, 2025

(54) APPARATUS AND METHOD FOR GENERATING PATH OF A VEHICLE

(71) Applicants: HYUNDAI MOTOR COMPANY, Seoul (KR); Kia Corporation, Seoul (KR)

(72) Inventor: Su Young CHOI, Seoul (KR)

(73) Assignees: HYUNDAI MOTOR COMPANY, Seoul (KR); Kia Corporation, Seoul (KR)

(21) Appl. No.: 18/538,363

(22) Filed: Dec. 13, 2023

(30) Foreign Application Priority Data
Jun. 28, 2023 (KR) 10-2023-0083577

(51) Int. Cl. B62D 15/02

(52) U.S. Cl. CPC B62D 15/0255; B60W 30/18163; B60W 60/001; B60W 2552/10; B60W 2554/4041; B60W 2556/40

(57) ABSTRACT

The present disclosure relates to a vehicle path generating apparatus and a method therefor. The vehicle path generating apparatus includes a processor and a storage configured to store data and algorithms, when executed by the processor, cause the processor to set a drivable region for cutting-in, to generate a cut-in path within the drivable region and in response a cut-in activation condition which is satisfied during autonomous driving of the vehicle, the processor configured to control a vehicle to follow the cut-in path, when there is no space available for performing lane change for the cutting-in, the processor configured to determine that the cut-in activation condition is satisfied.

This application claims priority to and the benefit of Korean Patent Application No. 10-2023-0083577, filed in the Korean Intellectual Property Office on Jun. 28, 2023, the entire contents of which are incorporated herein by reference.

### TECHNICAL FIELD

The present disclosure relates to a vehicle path generating apparatus and a method therefor, and more particularly, to a technique for generating a cut-in path for an autonomous vehicle.

### BACKGROUND

A vehicle includes an autonomous driving control apparatus for performing autonomous driving to automatically move to a destination using a navigation function, a lane recognition function, and an obstacle recognition function.

An autonomous vehicle that performs such autonomous driving requires the ability to adaptively respond to changing surroundings in real time while driving.

Particularly, in a situation such as lane merging, an autonomous vehicle needs to cut in, but the cut-in situation is different from a general lane change situation because there is not enough space for changing lanes. That is, in a state where there is no space available for lane change because another vehicle occupies the space in the merging lane, it is necessary to actively respond such as attempting to enter a space between other vehicles.

### SUMMARY

An exemplary embodiment of the present disclosure attempts to provide a vehicle path generating apparatus and a method therefor, capable of generating a cut-in path to perform cut-in control without collision in response to a case where there is no free space to change lanes because an object driving on a target lane into which a vehicle is trying to cut during autonomous driving occupies the space.

In addition, an exemplary embodiment of the present disclosure attempts to provide a vehicle path generating apparatus and a method therefor, capable of increasing performance of an autonomous vehicle by generating a cut-in path in consideration of a risk of collision and a minimum turning radius of the vehicle.

The technical objects of the present disclosure are not limited to the objects mentioned above, and other technical objects not mentioned may be clearly understood by those skilled in the art from the description of the claims.

An exemplary embodiment of the present disclosure provides a vehicle path generating apparatus including: a processor; and a storage configured to store data and algorithms, when executed by the processor, cause the processor to: set a drivable region for cutting-in, to generate a cut-in path within the drivable region and in response a cut-in activation condition which is satisfied during autonomous driving of the vehicle, the processor configured to control a vehicle to follow the cut-in path, when there is no space available for performing lane change for the cutting-in, the processor configured to determine that the cut-in activation condition is satisfied.

In an exemplary embodiment of the present disclosure, the processor may be configured to attempt to cut into a space between driving objects that exist in a target lane for merging during autonomous driving when the objects occupy a space of the target lane and there is no space in which lane change is to be performed.

In an exemplary embodiment of the present disclosure, the processor may be configured to determine that the cut-in activation condition is satisfied when the vehicle is driving on a merging lane, there is no space available for lane change in a target lane for lane change, and objects driving on the target lane are at a low speed below a predetermined speed.

In an exemplary embodiment of the present disclosure, when the target lane for the cutting-in is a first lane and the vehicle is driving on a second lane, the processor may be configured to set the drivable region using a right lane boundary of an own lane of the vehicle and a left lane boundary of the target lane.

In an exemplary embodiment of the present disclosure, when a first object and a second object driving in the target lane for the cutting-in exist, the processor is configured to set the left lane boundary of the target lane as a first left lane boundary, set a boundary between the first object and the second object as a second left lane boundary, and set a boundary between the second object and the vehicle as a third left lane boundary, and to set the drivable region by using the right lane boundary of the own lane of the vehicle, the first left lane boundary, the second left lane boundary, and the third left lane boundary.

In an exemplary embodiment of the present disclosure, the processor may be configured to set the first left lane boundary, the second left lane boundary, and the third left lane boundary to be continuously connected.

In an exemplary embodiment of the present disclosure, the processor may be configured to generate a grid map of a region from rear of the vehicle to a merging point, and to mark and display a boundary of the drivable region on the grid map. In some implementations, a position of the drivable region on the grid map includes an index.

In an exemplary embodiment of the present disclosure, the processor may be configured to set a first point moved forward by an overall length of the vehicle from a current position of an object driving in a target lane for the cutting-in, a second point moved forward by the overall length of the vehicle from the first point, a third point moved forward by the overall length of the vehicle from the current position of the vehicle, and a fourth point, which is the current position of the vehicle.

In an exemplary embodiment of the present disclosure, the processor may be configured to generate a first Bezier curve path using the first point, the second point, the third point, and the fourth point.

In an exemplary embodiment of the present disclosure, the processor may be configured to determine whether the first Bezier curve path partially or entirely overlaps the boundary of the drivable region to determine a risk of collision between the vehicle and an object driving on the target lane.

In an exemplary embodiment of the present disclosure, when the first Bezier curved path partially or entirely overlaps the boundary of the drivable region, the processor is configured to set a fifth point by moving the first point forward by a predetermined distance, and to generate a second Bezier curved path using the fifth point, the second point, the third point, and the fourth point.

In an exemplary embodiment of the present disclosure, the processor may be configured to determine whether the second Bezier curve path partially or entirely overlaps the boundary of the drivable region to determine a risk of collision between the vehicle and an object driving on the target lane, and the second Bezier curve path does not overlap the boundary of the drivable region the processor is configured to determine that there is no risk of collision between the vehicle and the object driving on the target lane, and to determine the fifth point as a target entry point into the target lane.

In an exemplary embodiment of the present disclosure, the processor may be configured to control the vehicle to drive on its own lane when both the first Bezier curve path and the second Bezier curve path overlap the boundary of the drivable region.

In an exemplary embodiment of the present disclosure, the processor may be configured to set the fifth point, the second point, the third point, and the fourth point, which are target entry points into the target lane, set a sixth point between the fifth point and the second point, and set a seventh point between the third point and the fourth point, to generate a third Bezier curve using the fifth point, the sixth point, the seventh point, and the fourth point.

In an exemplary embodiment of the present disclosure, the processor may be configured to determine that the third Bezier curve includes one or more points, and to compare a minimum radius of curvature of each of one or more points with a minimum turning radius of the vehicle, and to determine that the third Bezier curve as a cut-in path when the minimum radii of curvature of the one or more points are all greater than the minimum turning radius of the vehicle.

In an exemplary embodiment of the present disclosure, when at least one point having a minimum curvature radius that is smaller than the minimum turning radius of the vehicle exists among the one or more points, the processor is configured to change the sixth point and the seventh point to generate a fourth Bezier curve using the changed points, and to compare a minimum radius of curvature of the fourth Bezier curve with the minimum turning radius of the vehicle.

An exemplary embodiment of the present disclosure provides a vehicle path generating method including: determining, by a processor, whether a cut-in activation condition is satisfied during autonomous driving; in response to a determination that the cut-in activation condition is satisfied, setting a drivable region for cutting-in; generating a cut-in path within the drivable region; and controlling a vehicle to follow the cut-in path,

wherein the determining whether the cut-in activation condition is satisfied during autonomous driving may include determining that the cut-in activation condition is satisfied when there is no space available for performing lane change for the cutting-in.

In an exemplary embodiment of the present disclosure, the determining whether the cut-in activation condition is satisfied includes determining that the cut-in activation condition is satisfied when the vehicle is driving on a merging lane, there is no space available for lane change in a target lane for lane change, and objects driving on the target lane are at a low speed below a predetermined speed.

In an exemplary embodiment of the present disclosure, the setting of the drivable region may include, when the target lane for the cutting-in is a first lane and the vehicle is driving on a second lane,

setting the drivable region using a right lane boundary of an own lane of the vehicle and a left lane boundary of the target lane.

In an exemplary embodiment of the present disclosure, generating the cut-in path within the drivable region includes: setting a first point moved forward by an overall length of the vehicle from a current position of an object driving in a target lane for cutting-in, a second point moved forward by the overall length of the vehicle from the first point, a third point moved forward by the overall length of the vehicle from the current position of the vehicle, and a fourth point, which is the current position of the vehicle; generating a first Bezier curve path using the first point, the second point, the third point, and the fourth point; and determining whether the first Bezier curve path partially or entirely overlaps the boundary of the drivable region to determine a risk of collision between the vehicle and an object driving on the target lane.

According to the present technique, it is possible to generate a cut-in path to perform cut-in control without collision in response to a case where there is no free space to change lanes because an object driving on the target lane into which a vehicle is trying to cut during autonomous driving occupies the space.

In addition, according to the present technique, it is possible to increase performance of an autonomous vehicle by generating a cut-in path in consideration of a risk of collision and a minimum turning radius of the vehicle.

Furthermore, various effects that may be directly or indirectly identified through this document may be provided.

### BRIEF DESCRIPTION OF THE DRAWINGS

FIG. 1 illustrates a block diagram showing an example configuration of a vehicle path generating apparatus.

FIG. 2 illustrates a view for describing an example method of determining a drivable region that is a target region.

FIG. 3 illustrates a view for describing an example grid map generating method for collision determination.

FIG. 4 illustrates a view for describing an example method of determining a target entry point into a target lane.

FIG. 5 illustrates an example view for describing a Bezier curve.

FIG. 6 illustrates an example in which a driving path is generated by a host vehicle.

FIG. 7 illustrates a view for describing an example method of determining a control point in consideration of a minimum turning radius of a vehicle.

FIG. 8 illustrates a view for describing an example method of generating a cut-in path in consideration of a minimum turning radius of a vehicle.

FIG. 9 illustrates a view for describing an example method for determining whether driving on a cut-in path is possible.

FIG. 10 illustrates an example of generating a cut-in path.

FIG. 11 illustrates a flowchart showing an example method for generating a vehicle path for cutting in.

FIG. 12 illustrates a flowchart embodying an example cut-in path generating process.

FIG. 13 illustrates an example computing system.

### DETAILED DESCRIPTION

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. In describing an exemplary embodiment, when it is determined that a detailed description of the well-known configuration or function associated with the exemplary embodiment may obscure the gist of the present disclosure, it will be omitted.

In describing constituent elements according to an exemplary embodiment, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an exemplary embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

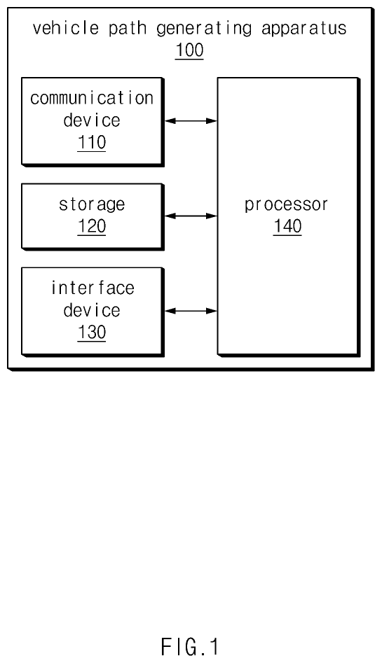

Hereinafter, various exemplary embodiments of the present disclosure will be described in detail with reference to FIG. 1 to FIG. 13.

FIG. 1 illustrates a block diagram showing an example configuration of a vehicle path generating apparatus. A vehicle according to the present disclosure may include an autonomous vehicle, a semi-autonomous vehicle, and the like that can operate by itself without a driver's or passenger's manipulation.

The vehicle path generating apparatus 100 according to an exemplary embodiment of the present disclosure may set a drivable region for cutting-in, may generate a cut-in path within the drivable region and control the vehicle to follow the cut-in path in response to a case where a cut-in activation condition is satisfied during autonomous driving of the vehicle.

That is, in response to a case where there are driving objects (other vehicles) in a target lane for merging during autonomous driving and the objects occupy a space of the target lane and there is no space in which lane change can be performed, the vehicle path generating apparatus 100 may attempt to cut into a space between the objects. In this case, the drivable region is a region in which a vehicle can drive to cut in, and the vehicle path generating apparatus 100 may determine the drivable region by using a right lane of an own lane in which the vehicle is driving, a left lane of the target lane, and the like.

The vehicle path generating apparatus 100 may be implemented inside the vehicle or separately therefrom. In this case, the vehicle path generating apparatus 100 may be integrally formed with internal control units of the vehicle, or may be implemented as a separate hardware device to be connected to control units of the vehicle by a connection means. For example, the vehicle path generating apparatus 100 may be implemented integrally with the vehicle, may be implemented in a form that is installed or attached to the vehicle as a configuration separate from the vehicle, or a part thereof may be implemented integrally with the vehicle, and another part may be implemented in a form that is installed or attached to the vehicle as a configuration separate from the vehicle.

Referring to FIG. 1, the vehicle path generating apparatus 100 may include a communication device 110, a storage 120, an interface device 130, and a processor 140.

The communication device 110 is a hardware device implemented with various electronic circuits to transmit and receive signals through a wireless or wired connection, and may transmit and receive information based on in-vehicle devices and in-vehicle network communication techniques. As an example, the in-vehicle network communication techniques may include controller area network (CAN) communication, local interconnect network (LIN) communication, flex-ray communication, and the like.

In addition, the communication device 110 may perform communication with a server, infrastructure, or third vehicles outside the vehicle, and the like through a wireless Internet access or short range communication technique. Herein, the wireless communication technique may include wireless LAN (WLAN), wireless broadband (Wibro), Wi-Fi, world Interoperability for microwave access (Wimax), etc. In addition, short-range communication technique may include bluetooth, ZigBee, ultra wideband (UWB), radio frequency identification (RFID), infrared data association (IrDA), and the like.

The communication device 110 may perform V2X communication. The V2X communication may include communication between vehicle and all entities such as V2V (vehicle-to-vehicle) communication which refers to communication between vehicles, V2I (vehicle to infrastructure) communication which refers to communication between a vehicle and an eNB or road side unit (RSU), V2P (vehicle-to-pedestrian) communication, which refers to communication between user equipment (UE) held by vehicles and individuals (pedestrians, cyclists, vehicle drivers, or occupants), and V2N (vehicle-to-network) communication.

The storage 120 may store data and/or algorithms required for the processor 140 to operate, and the like.

As an example, the storage 120 may store a Bezier algorithm or the like. In addition, the storage 120 may store algorithms for determining a minimum turning radius of the vehicle and a minimum curvature radius of a generated Bezier curve path.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the apparatus 100 and results thereof. Herein, the input means may include a key button, and may include a mouse, a joystick, a jog shuttle, a stylus pen, and the like. Furthermore, the input means may include a soft key implemented on the display.

The interface device 130 may be implemented as a head-up display (HUD), a cluster, an audio video navigation (AVN), or a human machine interface (HM), a human machine interface (HMI).

The output device may include a display, and may also include a voice output means such as a speaker. In the instant case, in a response to a case that a touch sensor formed of a touch film, a touch sheet, or a touch pad is provided on the display, the display may operate as a touch screen, and may be implemented in a form in which an input device and an output device are integrated. In the present disclosure, the output device may output the cut-in path so that a driver may check it.

In the instant case, the display may include at least one of a liquid crystal display (LCD), a thin film transistor liquid crystal display (TFT LCD), an organic light emitting diode display (OLED display), a flexible display, a field emission display (FED), a 3D display, or any combination thereof.

The processor 140 may be electrically connected to the communication device 110, the storage 120, the interface device 130, and the like, may electrically control each component, and may be an electrical circuit that executes software commands, thereby performing various data processing and calculations described below.

The processor 140 may perform overall control such that each component may normally perform their functions by processing a signal transferred between each component of the vehicle path generating apparatus 100. The processor 140 may be implemented in the form of hardware, software, or a combination of hardware and software. For example, the processor 140 may be implemented as a microprocessor, but the present disclosure is not limited thereto. For example, it may be, e.g., an electronic control unit (ECU), a micro controller unit (MCU), or other subcontrollers mounted in the vehicle. The processor 140 may be implemented by a non-transitory memory (e.g., storage 120) storing, e.g., a program(s), software instructions reproducing algorithms, etc., which, when executed, performs various functions described hereinafter, and a processor configured to execute the program(s), software instructions reproducing algorithms, etc. Herein, the memory (e.g., storage 120) and the processor 140 may be implemented as separate semiconductor circuits. Alternatively, the memory (e.g., storage 120) and the processor 140 may be implemented as a single integrated semiconductor circuit. The processor 140 may embody one or more processor(s).

The processor 140 may set a drivable region for cutting-in, may generate a cut-in path within the drivable region and control the vehicle to follow the cut-in path in response to a case where a cut-in activation condition is satisfied during autonomous driving of the vehicle.

The processor 140 may determine that the cut-in activation condition is satisfied in a state where the vehicle is driving on a merging lane, there is no space available for lane change in a target lane for lane change, and objects driving on the target lane are at a low speed below a predetermined speed.

The processor 140 may set a drivable region using a right lane boundary of an own lane of the vehicle and a left lane boundary of the target lane in a state where the target lane for cutting in is a first lane and the vehicle is driving on a second lane.

In addition, in a state where there are a first object and a second object driving on the target lane for cutting-in, the processor 140 may set a left lane boundary of the target lane as a first left lane boundary, may set a boundary between the first object and the second object as a second left lane boundary, may set a boundary between the second object and the vehicle as a third left lane boundary, and may set the drivable region by using the right lane boundary of the own lane of the vehicle, the first left lane boundary, the second left lane boundary, and the third left lane boundary. In this case, the processor 140 may set the first left lane boundary, the second left lane boundary, and the third left lane boundary to be continuously connected.

The processor 140 may select an object that is positioned in front of the vehicle, is positioned further than a distance determined based on a speed of the vehicle, and closest to the vehicle as the first object and may select an object driving behind the first object as the second object among objects driving on the target lane for merging during autonomous driving.

The processor 140 may generate a grid map of a region from rear of the vehicle to a merging point, and may mark and display a boundary of the drivable region on the grid map. In this case, a position of the drivable region on a grid map may include an index.

The processor 140 may set a first point moved forward by a predetermined first length (an overall length of the host vehicle) from a current position of the object driving on the target lane for cutting-in, a second point moved forward from the first point by a predetermined second length (e.g., 1 m), a third point moved forward by the first length from the current position of the vehicle, and a fourth point, which is the current position of the vehicle.

The processor 140 may generate a first Bezier curve path using the first point, the second point, the third point, and the fourth point, may determine whether the first Bezier curve path partially or entirely overlaps the boundary of the drivable region to determine a risk of collision between the vehicle and an object driving on the target lane. The processor 140 may determine that there is the risk of collision in response to a case where the first Bezier curved path overlaps a boundary of the drivable region.

The processor 140 may set a fifth point by moving the first point forward by a predetermined distance in response to a case where the first Bezier curved path overlaps the boundary of the drivable region, and may generate a second Bezier curved path using the fifth point, the second point, the third point, and the fourth point.

Subsequently, the processor 140 may determine whether the second Bezier curve path overlaps the boundary of the drivable region, may determine whether a risk of collision between the vehicle and an object driving on the target lane, may determine that there is no risk of collision between the vehicle and the object driving on the target lane in response to a case where the second Bezier curve path does not overlap the boundary of the drivable region, and may determine the fifth point as a target entry point into the target lane.

In response to a case where the second Bezier curve path overlap the boundary of the drivable region, the processor 140 may not determine the target entry point into the target lane, and may control the vehicle to drive on its own lane.

The processor 140 may additionally set a sixth point that moves forward by a predetermined first length from a fifth point, which is a target entry point into the target lane, may set a seventh point between the fifth point and the sixth point, and may set an eighth point between the third point and the fourth point, to generate a third Bezier curve using the fifth point, the seventh point, the eighth point, and the fourth point.

The processor 140 may determine that the third Bezier curve includes one or more points, and may compare a minimum radius of curvature of each of one or more points with a minimum turning radius of the vehicle, and may determine that the third Bezier curve as a cut-in path in response to a case where the minimum radii of curvature of the one or more points are all greater than the minimum turning radius of the vehicle.

In response to a case where there is at least one point smaller than the radius, the processor 140 may change the seventh point and the eighth point to generate a fourth Bezier curve using the changed points, and may compare a minimum radius of curvature of the fourth Bezier curve with the minimum turning radius of the vehicle.

As such, according to the present disclosure, in a situation where the vehicle needs to cut in during autonomous driving, optimal cut-in control may be performed to increase reliability of the autonomous vehicle by setting the drivable region, and then generating a cut-in path within the drivable region and determining a drivable cut-in path in consideration of a minimum radius of curvature of the cut-in path and the minimum turning radius of the vehicle.

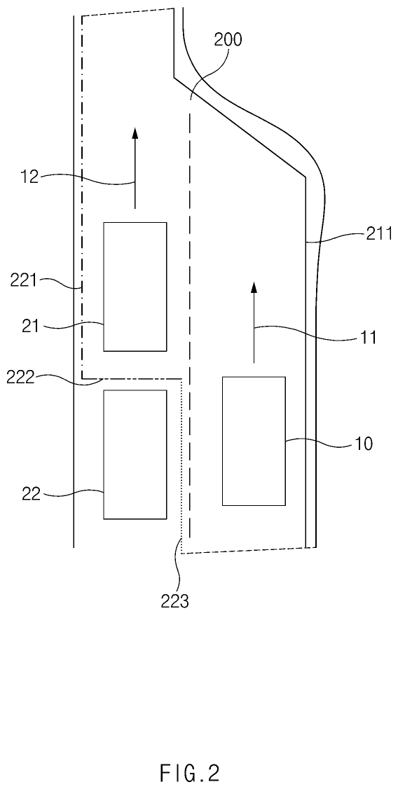

FIG. 2 illustrates a view for describing an example method of determining a drivable region that is a target region.

Referring to FIG. 2, the vehicle path generating apparatus 100 may set a target region (a drivable region 200) in response to a case where a first object 21 and a second object 22 exist in a target lane 12 to which a host vehicle 10 intends to enter and the host vehicle 10 tries to cut in between the first object 21 and the second object 22. In this case, the vehicle path generating apparatus 100 may select an object that is positioned in front of the host vehicle 10, positioned further than a distance determined based on a speed of the host vehicle 10, and closest to the vehicle 10 as a first object 21 and may select an object driving behind the first object 21 as a second object 22 among the objects driving on the target lane for merging during autonomous driving. For example, in a state where the speed of the host vehicle 10 is 8.3 mps, a lateral control distance becomes 5.4 m by multiplying the speed (8.3 mps) and a predetermined coefficient (e.g., 0.65). Accordingly, an object positioned more than 5.4 m away from the host vehicle 10 may be selected as the first object 21.

The vehicle path generating apparatus 100 sets a right lane of an own lane 11 as a right boundary 211 of the drivable region 200, and sets a left lane of the target lane 12 as a first left boundary 221 of the drivable region 200. In addition, the vehicle path generating apparatus 100 sets a second left boundary 222 between the first object 21 and the second object 22, and the second left boundary 222 of the drivable region 200 is connected to the first left boundary 221 of the drivable region 200.

In addition, the vehicle path generating apparatus 100 may set a lane between a right side of the second object 22 and a left side of the host vehicle 10 as a third left boundary 223 of the target region 200, and the third left boundary 223 is connected to the second left boundary 222.

As such, the vehicle path generation apparatus 100 sets the drivable region 200 based on the right boundary 211, the first left boundary 221, the second left boundary 222, and the third left boundary 223.

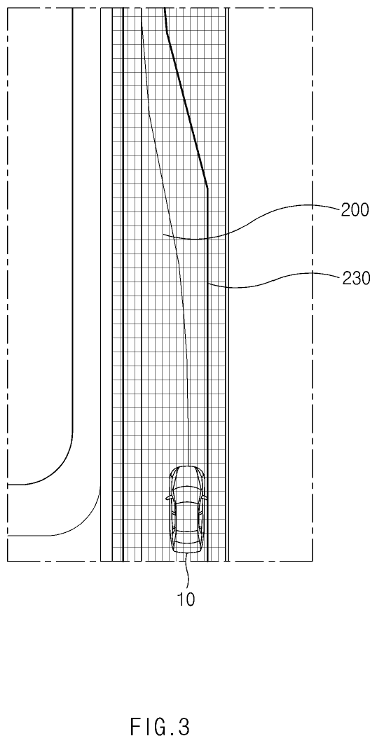

Then, to generate the cutting-in path, the vehicle path generating apparatus 100 generates a grid map for collision determination as illustrated in FIG. 3. FIG. 3 illustrates a view for describing an example grid map generating method for collision determination.

Referring to FIG. 3, in order to determine whether a cut-in path collides with a boundary 230 of the drivable region 200, the vehicle path generating apparatus 100 generates an entire grid map including an own lane and a target lane, and marks the boundary 230 of the drivable region 200 on the grid map. In this case, a position of each drivable region 200 on the grid map may be stored in the form of an index (x, y).

The vehicle path generating apparatus 100 may generate the grid map in a region from a predetermined distance (e.g., 10 m) from rear of the vehicle to a cut-in point (e.g., a merging point).

The vehicle path generating apparatus 100 may determine that there is a risk of collision in response to a case where the cutting-in path overlaps or meets the boundary 230 of the drivable region 200.

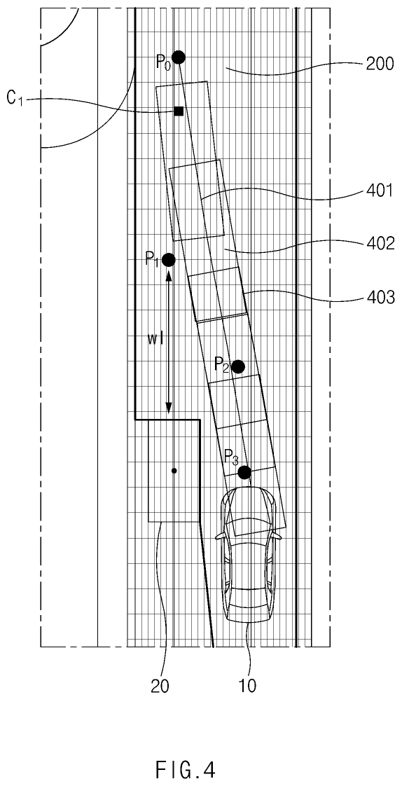

As such, the risk of collision is determined, and in response to a case where it is determined that there is no risk of collision, as illustrated in FIG. 4, it is possible to determine a target entry point into a target lane. In this case, the entry target point into the target lane indicates a target point for entering the target lane.

FIG. 4 illustrates a view for describing an example method of determining a target entry point into a target lane.

Referring to FIG. 4, in response to entering the target lane, the vehicle path generating apparatus 100 may set a point positioned ahead of the rear object 20 by an entire length wl of the host vehicle as a point P₁ for determining the target point of the target lane. In addition, a point positioned ahead of the target point P₁ by the length wl of the host vehicle is set as a point P₀.

The vehicle path generating apparatus 100 sets a central position of the front (e.g., front bumper) of the host vehicle 10 as a point P₃ as the position of the host vehicle 10, and sets a point positioned in front of the point P₃ by the overall length wl of the host vehicle 10 as a point P₂.

The vehicle path generating apparatus 100 may apply four points P₀, P₁, P₂, and P₃ to a Bezier algorithm to generate a Bezier curved path 401. In this case, in response to applying points P₀, P₁, P₂, and P₃ to the Bezier algorithm, the points P₀ and P₃ are positioned on the Bezier curve path 401, but the points P₁ and P₂ are not positioned on the Bezier curve path 401.

In this case, in response to applying points P₀, P₁, P₂, and P₃ to the Bezier algorithm, the points P₀ and P₃ are positioned on the Bezier curve path 401, but the points P₁ and P₂ are not positioned on the Bezier curve path 401. That is, the vehicle path generating apparatus 100 generates a Bezier curve path by moving the point P₀ forward from the point P₁ n times by a predetermined length while fixing the points P₁, P₂, and P₃, and determines whether the generated Bezier path according to a position of the point P₀ has an index that overlaps the drivable region 200. In FIG. 4, a box 403 tracking a movement of the vehicle 10 along the curved path 401 is illustrated, it may be determined that there is a risk of collision in response to a case where a vehicle width 402 touches a boundary of the drivable region 200 in moving the vehicle 10.

The vehicle path generating apparatus 100 may form a Bezier curve path in a shape of the box 403 based on a vehicle width, and may determine whether there is a risk of a collision between the host vehicle 10 and an object driving on the target lane by determining whether the box-shaped Bezier curve path overlaps a boundary of the drivable region 200.

That is, the vehicle path generating apparatus 100 determines a point where the point P₁ is moved 1 m forward in the driving direction of the target lane from P₁ as the point P0, and then applies the four points P₀, P₁, P₂, and P₃ to the Bezier algorithm to generate a Bezier curve path and determines whether the generated Bezier curve path overlaps a boundary of the drivable region 200. In response to a case where the generated Bezier curve path overlaps the boundary of the drivable region 200, the vehicle path generating apparatus 100 redetermines a point where the point P₁ is moved 1 m further forward as the point P₀, regenerates the Bezier curve path by reapplying the redetermined point P₀ and the fixed points P₁, P₂, and P₃ to the Bezier algorithm, determines whether the regenerated Bezier curve path overlaps the boundary of the drivable region 200. As such, it may be possible to move the point P₁ further forward 1 m until the regenerated Bezier curve path does not overlap the boundary of the drivable region 200, the point P₀ at which the Bezier curve path does not overlap the boundary of the drivable region 200 may be determined as the target entry point C₁ into the target lane.

As described above, until the point P₀ is determined as the target entry point C₁ into the target lane, one or more Bezier curve paths formed between the point P₁ and the point P₀ may correspond to a first Bezier curve path, and one Bezier curve path formed using the final point P₀ may correspond to a second Bezier curve path.

In this way, the vehicle path generating apparatus 100 may repeat a process of moving a position of the point P₁ 2 to 3 times to obtain the point P₀ at a time point the Bezier curve path does not overlap the boundary of the drivable region 200. In this case, repeating the process of moving the position of the point P₀ 2 to 3 times is to avoid moving the position of the point P₀ beyond the overall length of the host vehicle 10.

As such, the position of the corresponding point P₀ may be determined as the target entry point C₁ into the target lane in response to a case where the Bezier curve path according to the position of the point P₀ does not overlap the drivable region 200.

In this way, according to the present disclosure, a shortest lane change path may be determined by determining the point P₀ as a point with a closest longitudinal distance from the host vehicle. That is, the point P₀ indicates a closest position to the host vehicle 10 without collision, so no collision occurs anywhere in front of the point P₀.

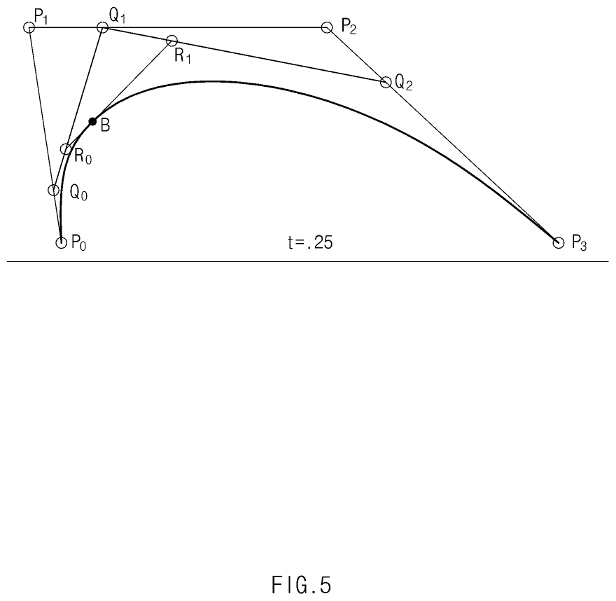

FIG. 5 illustrates an example view for describing a Bezier curve.

Referring to FIG. 5, the vehicle path generating apparatus 100 may generate a curve in the form of a cubic equation using four points P₀, P₁, P₂, and P₃. A Bezier curve path may be generated by linear interpolation by generating a second Bezier curve using the previous three points P₀, P₁, and P₂, and a second Bezier curve using the following three points P₁, P₂, and P₃.

A formula for determining the Bezier curve path is illustrated in Equation 1 below.

$$B ( t ) = {( 1 - t )}^{3} {P}_{0} + 3 {( 1 - t )}^{2} {tP}_{1} + 3 ( 1 - t ) {t}^{2} {P}_{2} + {t}^{3} {P}_{3} \qquad ( Equation 1 )$$

$$0 \leq t \leq 1$$

At this time, t refers to a variable for the moving distance.

In FIG. 5, Q₀ indicates an internally dividing point between P₀ and P₁, Q₁ indicates an internally dividing point between P₁ and P₂, Q₂ indicates an internally dividing point between P₂ and P₃, R₀ indicates an internally dividing point between Q₀ and Q₁, R₁ indicates an internally dividing point between Q₁ and Q₂, and B indicates an internally dividing point between R₀ and R₁.

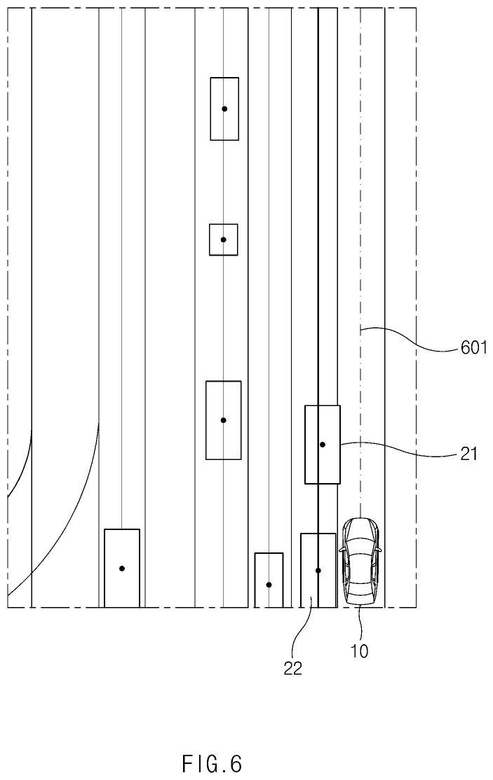

FIG. 6 illustrates an example in which a driving path is generated by a host vehicle.

Referring to FIG. 6, the vehicle path generating apparatus 100 may generate a path 601 that is drivable along an own lane in response to a case where an target entry point into the target lane is not determined, that is, a Bezier curved path that does not overlap the drivable region 200 is not determined.

The vehicle path generating apparatus 100 may redetermine the target entry point into the target lane while driving along the own lane.

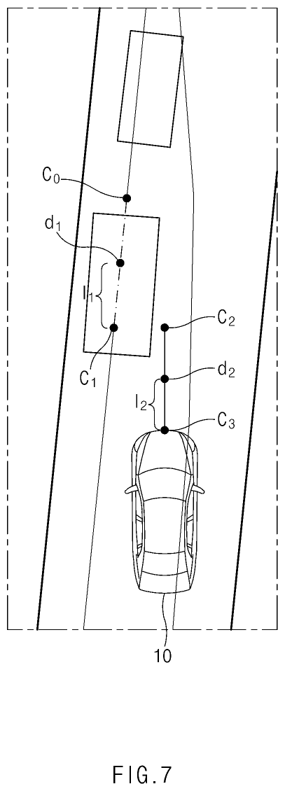

FIG. 7 illustrates a view for describing an example method of determining a control point in consideration of a minimum turning radius of a vehicle.

Referring to FIG. 7, in response to a case where the target entry point into the target lane is determined, the vehicle path generating apparatus 100 may determine a control point where a minimum curvature radius of the path is greater than the minimum turning radius of the vehicle.

The vehicle path generating apparatus 100 may set points C₀, C₂, and C₃ for generating a lane change path based on the previously determined target entry point C₁ into the target lane.

That is, the point C₀ is a position moved forward by the length of the host vehicle from the point C₁, the point C₁ indicates a minimum target entry position where the vehicle does not collide with the boundary of the drivable region 200, the point C₂ indicates a position moved forward by the length of the host vehicle from the point C₃, and the point C₃ indicates a current position of the host vehicle.

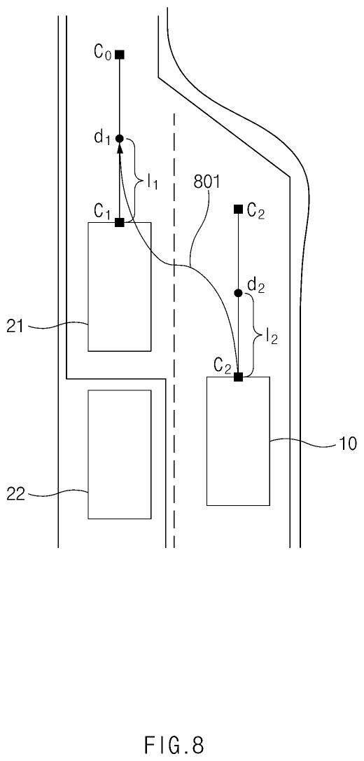

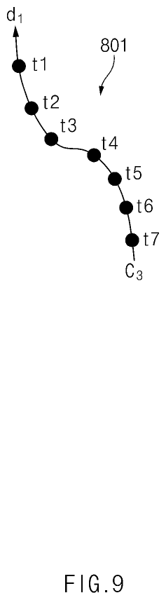

FIG. 8 illustrates a view for describing an example method of generating a cut-in path in consideration of a minimum turning radius of a vehicle, and FIG. 9 illustrates a view for describing an example method for determining whether driving on a cut-in path is possible.

Referring to FIG. 8, the vehicle path generating apparatus 100 may change points d₁ and d₂, that is, adjust lengths l₁ and l₂, and may generate a third Bezier curved path 801 using the four points C₁, d₁, d₂, and C₃. In this case, an interval between the lengths l₁ and l₂ may be determined in advance by an experimental value. In addition, the point d₁ indicates a control point of the points C₀ and C₁, and the point d₂ indicates a control point of points C₂ and C₃.

The vehicle path generating apparatus 100 may check whether a minimum curvature radius of the generated Bezier curve path 801 is greater than the minimum turning radius of the vehicle, and in response to a case where the minimum curvature radius of the Bezier curve path 801 is smaller than the minimum turning radius of the vehicle, regenerates the Bezier curved path by changing the point d₁ and the point d₂.

The vehicle path generating apparatus 100 may repeat the above process until a Bezier curved path having a minimum radius of curvature greater than the minimum turning radius of the vehicle is generated.

In response to a case where the minimum radius of curvature of the generated Bezier curve path 801 is greater than the minimum turning radius of the vehicle, the vehicle path generating apparatus 100 may use the corresponding curve as a lane change path (fourth Bezier curved path).

As illustrated in FIG. 9, the Bezier curve path 801 includes at least one or more points t1 to t7, and the vehicle path generating apparatus 100 may check whether the minimum curvature radius of each of the points t1 to t7 of the Bezier curve path 801 is greater than the minimum turning radius of the vehicle, and in response to a case where the minimum curvature radii of all the points t1 to t7 are greater than the minimum turning radius of the vehicle, may determine that the minimum curvature radius of the corresponding Bezier curve path 801 is greater than the minimum turning radius of the vehicle to determine the corresponding curved path as the lane change path.

That is, in response to a case where the minimum radius of curvature of any one of the points t1 to t7 is smaller than the minimum turning radius of the vehicle, it is determined that the minimum curvature radius of the corresponding Bezier curve path 801 is smaller than the minimum turning radius of the vehicle, and thus the corresponding path is not used.

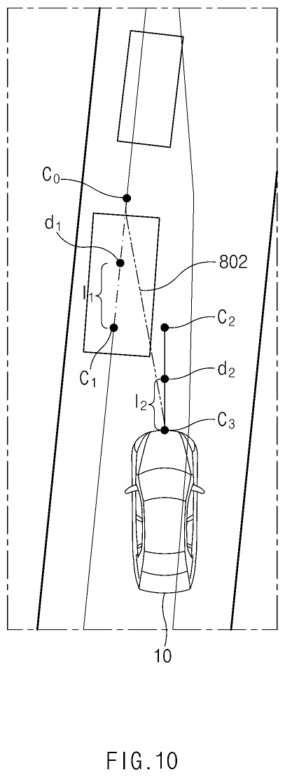

FIG. 10 illustrates an example of generating a cut-in path.

Referring to FIG. 10, the vehicle path generating apparatus 100 generates a cut-in path 802 based on a final Bezier curve, and the vehicle 10 drives while following the corresponding path 802.

As such, according to the present disclosure, in response to an attempt on cut-in control during autonomous driving, it is possible to determine whether there is a risk of collision between the host vehicle and another vehicle while cutting in by setting a drivable region, and although there is no risk of collision between the host vehicle and another vehicle, it is possible to accurately perform the cut-in control during autonomous driving by determining a final cut-in path by determining whether the minimum radius of curvature of the generated cut-in path satisfies a minimum turning radius of the host vehicle.

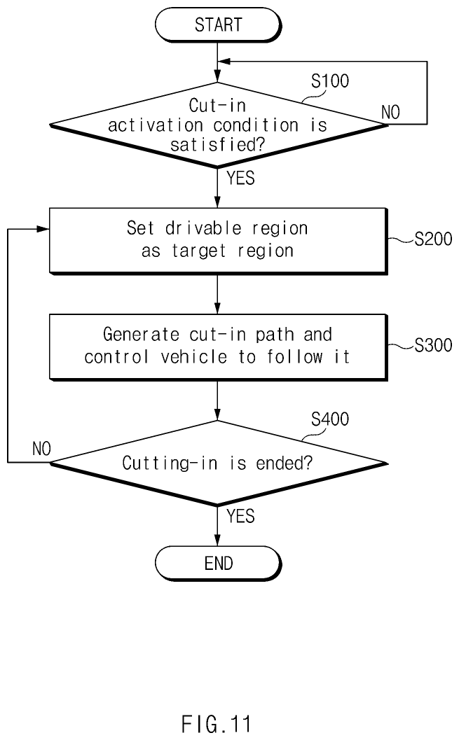

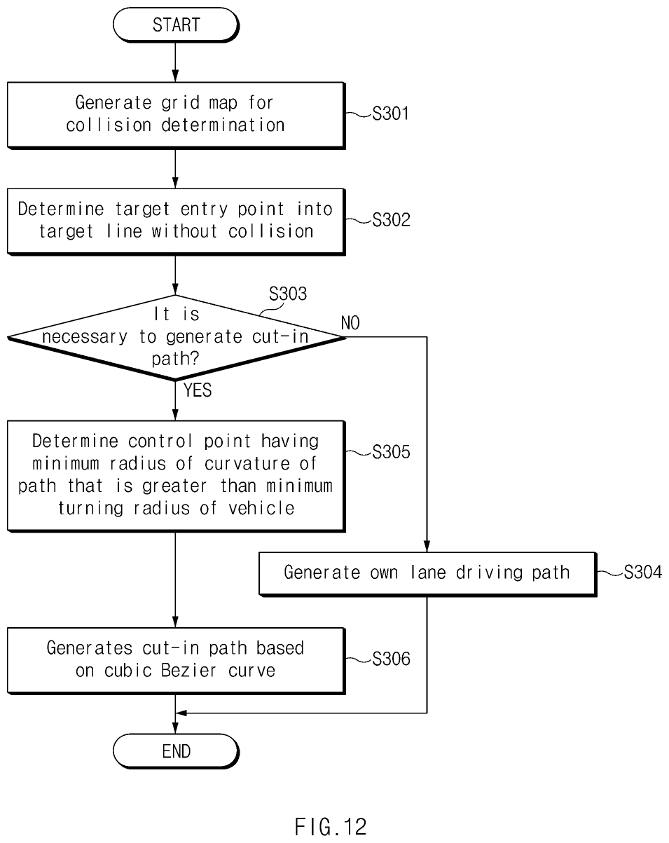

Hereinafter, a vehicle path generating method for cutting in of an autonomous vehicle according to an exemplary embodiment of the present disclosure will be described in detail with reference to FIG. 11 and FIG. 12. FIG. 11 illustrates a flowchart showing an example method for generating a vehicle path for cutting in, and

FIG. 12 illustrates a flowchart embodying an example cut-in path generating process.

Hereinafter, it is assumed that the vehicle path generating apparatus 100 of FIG. 1 performs the processes of FIG. 11 and FIG. 12. In addition, in the description of FIG. 11 and FIG. 12, operations described as being performed by the device may be understood as being controlled by the processor 140 of the vehicle path generating apparatus 100.

Referring to FIG. 11, the vehicle path generating apparatus 100 determines whether a cut-in activation condition is satisfied while the vehicle is driving (S100).

The vehicle path generating apparatus 100 may determine that the cut-in activation condition is satisfied in response to a case where a vehicle is driving on a merging lane, there is no available space for lane change in a target lane for lane change, and objects in the target lane are driving at a low speed (e.g., 5 kph).

Subsequently, the vehicle path generating apparatus 100 sets the drivable region 200 as a target region (S200). In this case, as illustrated in FIG. 2 described above, the drivable region 200 may be set using a right lane of an own lane where a host vehicle is driving, a left lane of a target lane into which the host vehicle wants to cut, a lane between first and second objects in the target lane, and a lane between the second object and the host vehicle.

The vehicle path generating apparatus 100 generates a cut-in path for cut-in control within the drivable region 200 and controls the host vehicle to follow the cut-in path (S300). In this case, the generation of the cut-in path will be described in more detail with reference to FIG. 12 later.

The vehicle path generating apparatus 100 determines whether such cutting-in is completed (S400), and ends a corresponding logic when the cutting-in is completed. In this case, the vehicle path generating apparatus 100 may determine that the cutting-in is completed in response to a case where the vehicle reaches a target entry point of the target lane.

Hereinafter, a process of generating the cut-in path in step S300 will be described in detail with referring to FIG. 12.

The vehicle path generating apparatus 100 generates a grid map for collision determination (S301). As illustrated in FIG. 3 described above, the vehicle path generating apparatus 100 generates a grid map of a region from rear of the vehicle to a merging point at a predetermined distance in a rear direction, and displays a boundary of the drivable region on the grid map.

The vehicle path generating apparatus 100 determines the target entry point into the target lane without a collision (S302). As illustrated in FIG. 4 described above, the vehicle path generating apparatus 100 determines the target entry point into the target lane that does not collide between boundaries of the cutting-in path and the drivable region 200.

After completing the process of determining the target entry point into the target lane, the vehicle path generating apparatus 100 determines whether it is necessary to generate the cut-in path (S303).

That is, the vehicle path generating apparatus 100 may determine whether it is necessary to generate the cut-in path by determining whether the target entry point into the target lane has been determined.

That is, in response to a case where the target entry point into the target lane is determined, the cut-in path may be generated based on the target entry point into the target lane, but in response to a case where the target entry point into the target lane is not determined (there is a risk of collision between all cut-in paths and the boundary of the drivable region 200), an own lane driving path is generated to drive on the own lane instead of the cut-in path.

As illustrated in FIG. 6 described above, the vehicle path generating apparatus 100 controls driving of the vehicle along the own lane driving path (S304).

On the other hand, in response to a case where the target entry point into the target lane is determined, the vehicle path generating apparatus 100 determines a control point having a minimum radius of curvature of the path that is greater than a minimum turning radius of the vehicle (S305), and generates a cut-in path based on a cubic Bezier curve (S306).

As illustrated in FIG. 8 and FIG. 9 described above, four points are set based on the target entry point into the target lane, and the Bezier curve path is generated using the four points, and thus the corresponding Bezier curve path is determined as the cut-in path in response to a case where the minimum radius of curvature of the Bezier curve path is greater than the minimum turning radius of the vehicle.

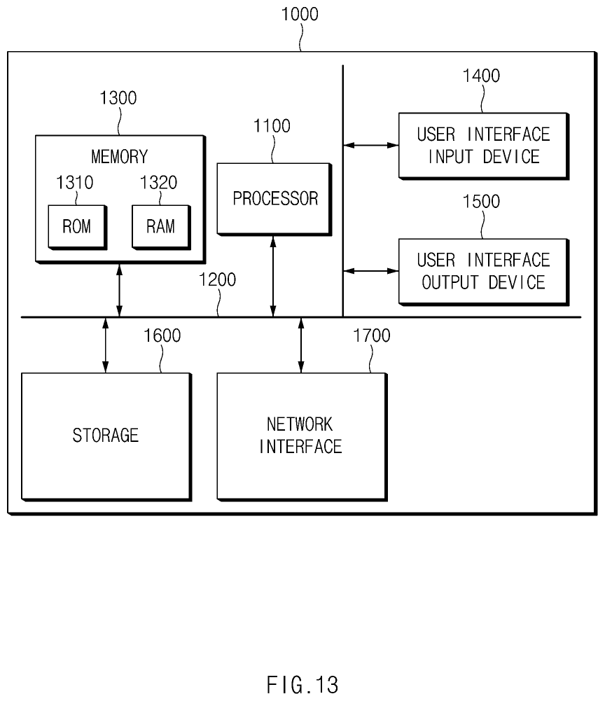

FIG. 13 illustrates an example computing system.

Referring to FIG. 13, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which may read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. A vehicle path generating apparatus comprising:
a processor; and
a storage configured to store data and algorithms, when executed by the processor, cause the processor to:
set a drivable region for cutting-in, to generate a cut-in path within the drivable region and in response a cut-in activation condition which is satisfied during autonomous driving of the vehicle, the processor configured to control a vehicle to follow the cut-in path,
when there is no space available for performing lane change for the cutting-in, the processor configured to determine that the cut-in activation condition is satisfied,
wherein the processor electrically connected to a steering apparatus of a vehicle configured to control a steering of the vehicle for the vehicle to follow the cut-in path.

2. The vehicle path generating apparatus of claim 1, wherein
the processor is configured to attempt to cut into a space between driving objects that exist in a target lane for merging during autonomous driving when the objects occupy a space of the target lane and there is no space in which lane change is to be performed.

3. The vehicle path generating apparatus of claim 1, wherein
the processor is configured to determine that the cut-in activation condition is satisfied when the vehicle is driving on a merging lane and objects driving on the target lane are at a low speed below a predetermined speed.

4. The vehicle path generating apparatus of claim 1, wherein
when the target lane for the cutting-in is a first lane and the vehicle is driving on a second lane,
the processor is configured to set the drivable region using a right lane boundary of an own lane of the vehicle and a left lane boundary of the target lane.

5. The vehicle path generating apparatus of claim 4, wherein
when a first object and a second object driving in the target lane for the cutting-in exist,
the processor is configured to set the left lane boundary of the target lane as a first left lane boundary, set a boundary between the first object and the second object as a second left lane boundary, and set a boundary between the second object and the vehicle as a third left lane boundary, to set the drivable region by using the right lane boundary of the own lane of the vehicle, the first left lane boundary, the second left lane boundary, and the third left lane boundary, and to set the first left lane boundary, the second left lane boundary, and the third left lane boundary to be continuously connected.

6. The vehicle path generating apparatus of claim 1, wherein
the processor is configured to generate a grid map of a region from rear of the vehicle to a merging point, and to mark and display a boundary of the drivable region on the grid map wherein a position of the drivable region on the grid map includes an index.

7. The vehicle path generating apparatus of claim 1, wherein
the processor is configured to set a first point moved forward by a predetermined first length from a current position of an object driving in a target lane for the cutting-in, a second point moved forward by a predetermined second length from the first point, a third point moved forward by the predetermined first length from a current position of the vehicle, and a fourth point, which is the current position of the vehicle.

8. The vehicle path generating apparatus of claim 7, wherein
the processor is configured to generate a first Bezier curve path using the first point, the second point, the third point, and the fourth point.

9. The vehicle path generating apparatus of claim 8, wherein
the processor is configured to set the fifth point where the first Bezier curved does not overlap the boundary of the drivable region by moving the first point forward at least once by a predetermined second length.

10. The vehicle path generating apparatus of claim 9, wherein
the processor is configured to determine whether the first Bezier curve path overlaps the boundary of the drivable region to determine a risk of collision between the vehicle and an object driving on the target lane.

11. The vehicle path generating apparatus of claim 10, wherein
when the first Bezier curved path overlaps the boundary of the drivable region,
the processor is configured to set a fifth point by moving the first point forward by the second length, and to generate a second Bezier curved path using the fifth point, the second point, the third point, and the fourth point.

12. The vehicle path generating apparatus of claim 11, wherein
the processor is configured to determine whether the second Bezier curve path overlaps the boundary of the drivable region to determine a risk of collision between the vehicle and an object driving on the target lane, when the second Bezier curve path does not overlap the boundary of the drivable region the processor is configured to determine that there is no risk of collision between the vehicle and the object driving on the target lane, and to determine the fifth point as a target entry point into the target lane.

13. The vehicle path generating apparatus of claim 11, wherein
the processor is configured to control the vehicle to drive on its own lane when the second Bezier curve path overlap the boundary of the drivable region.

14. The vehicle path generating apparatus of claim 11, wherein
the processor is configured to generates a cut-in path having a minimum curvature radius that is greater than a minimum turning radius of a vehicle based on the target entry point into the target lane.

15. The vehicle path generating apparatus of claim 11, wherein
the processor is configured to set a sixth point moving forward by a predetermined first length from the fifth point, a seventh point between the fifth point and the sixth point, and an eighth point between the third point and the fourth point, and
the processor is further configured to generate a third Bezier curve using the fifth point, the seventh, the eighth point, and the fourth point.

16. The vehicle path generating apparatus of claim 15, wherein
the processor is configured to compare a minimum curvature radius of each of one or more points included in the third Bezier curved line with a minimum turning radius of the vehicle, and to determine that the third Bezier curve as a cut-in path when the minimum radii of curvature of the one or more points are all greater than the minimum turning radius of the vehicle.

17. The vehicle path generating apparatus of claim 15, wherein
when at least one point having a minimum curvature radius that is smaller than the minimum turning radius of the vehicle exists among the one or more points,
the processor is configured to change the seventh point and the eighth point to generate a fourth Bezier curve using the changed points, and to compare a minimum radius of curvature of the fourth Bezier curve with the minimum turning radius of the vehicle.

18. A vehicle path generating method comprising:
determining, by a processor, whether a cut-in activation condition is satisfied during autonomous driving;
in response to a determination that the cut-in activation condition is satisfied, setting a drivable region for cutting-in;
generating a cut-in path within the drivable region; and
controlling a vehicle to follow the cut-in path,
wherein the determining whether the cut-in activation condition is satisfied during autonomous driving includes determining that the cut-in activation condition is satisfied when there is no space available for performing lane change for the cutting-in.

19. The vehicle path generating method of claim 18, wherein
the determining whether the cut-in activation condition is satisfied includes:
determining that the cut-in activation condition is satisfied when the vehicle is driving on a merging lane, there is no space available for lane change in a target lane for lane change, and objects driving on the target lane are at a low speed below a predetermined speed.

20. The vehicle path generating apparatus of claim 18, wherein
generating the cut-in path within the drivable region includes: setting a first point moved forward by a predetermined first length from a current position of an object driving in a target lane for cutting-in, a second point moved forward by a predetermined second from the first point, a third point moved forward by the predetermined first length from a current position of the vehicle, and a fourth point, which is the current position of the vehicle;
generating a first Bezier curve path using the first point, the second point, the third point, and the fourth point; and
determining whether the first Bezier curve path overlaps the boundary of the drivable region to determine a risk of collision between the vehicle and an object driving on the target lane.
